(19) United States
(12) Patent Application Publication
(10) Pub. No.: US 2020/0088687 A1
(43) Pub. Date: Mar. 19, 2020

(54) AUTOREGRESSIVE SIGNAL PROCESSING APPLIED TO HIGH-FREQUENCY ACOUSTIC MICROSCOPY OF SOFT TISSUES

(71) Applicants: Daniel Rohrbach, Monroe, WA (US); Jonathan Mamou, New York, NY (US)

(72) Inventors: Daniel Rohrbach, Monroe, WA (US); Jonathan Mamou, New York, NY (US)

(73) Assignee: Riverside Research Institute, New York, NY (US)

(21) Appl. No.: 16/569,054

(22) Filed: Sep. 12, 2019

Related U.S. Application Data
(60) Provisional application No. 62/730,578, filed on Sep. 13, 2018.

(51) Int. Cl. G01N 29/11; G01N 29/24; G01N 29/28; G01N 29/44

(52) U.S. Cl. CPC G01N 29/11; G01N 29/2431; G01N 2291/011; G01N 29/44; G01N 2291/02475; G01N 29/28

(57) ABSTRACT

A method to create a parameter map depicting acoustical and mechanical properties of biological tissue at microscopic resolutions to identify potential health related issues. The method including mounting the biological tissue on a substrate, raster scanning the biological tissue with an RF frequency, recovering RF echo signals from said substrate and from a plurality of locations on said biological tissue, wherein each of the plurality of locations corresponds to a specific pixel comprising the parameter map, the recovered RF echo signals including a reference signal recovered from the substrate at a point devoid of tissue, a first sample signal recovered from an interface between the biological tissue and water, and a second sample signal recovered from an interface between said biological tissue and said substrate, repeatedly applying a plurality of computer-generated calculation steps based on the reference signal, the first sample signal and the second sample signal to generate estimated values for a plurality of parameters associated with each of the specific pixels in the parameter map. The plurality of computer-generated calculation steps includes a denoising step, and using the generated estimated values to create said parameter map depicting parameters including, but not limited, to acoustic impedance, speed of sound, ultrasound attenuation, mass density, bulk modulus and nonlinear attenuation.

### PRIORITY AND RELATED APPLICATION

This application claims priority to U.S. Provisional Patent Application No. 62/730,578 filed Sep. 13, 2018, entitled “AUTOREGRESSIVE SIGNAL PROCESSING APPLIED TO HIGH-FREQUENCY ACOUSTIC MICROSCOPY OF SOFT TISSUES” and is hereby incorporated by reference in its entirety.

### FIELD OF THE INVENTION

The present invention relates to an imaging tool using a novel autoregressive model to improve signal processing and parameter estimation of biological tissue.

### BACKGROUND

Scanning acoustic microscopy (SAM), has become an established imaging tool to characterize acoustical (e.g., speed of sound, acoustic impedance, attenuation) and mechanical (e.g., bulk modulus, mass density) properties of soft and hard biological tissues at microscopic resolutions using ultrasound frequencies between 100 MHz and 1.5 GHz. Although spatial resolution of SAM is coarser than that of optical microscopy images, SAM's ability to scan unstained and unfixed tissues and the derived unique tissue properties that cannot be obtained using other microscopy methods attribute to the high relevance of SAM for other research areas.

Although SAM is a mature technology, estimating all material properties in a single measurement remains a challenging task, particularly at frequencies greater than 200 MHz. Another tool was established, quantitative-acoustic-microscopy (QAM), developed and is used to obtain high-quality images of acoustic parameters of soft tissues at 250 MHz and 500 MHz. The system scans thin (i.e., 5 to 14 μm) soft-tissue sections that are attached to a glass plate (i.e., substrate) and records radio-frequency (RF) signals that originate from ultrasound reflections from the sample surface and sample-glass-plate interface, respectively. This approach allows a single measurement to obtain an estimate of acoustic impedance (Z), speed of sound (c), and ultrasound attenuation (α) as well mass density (ρ) and bulk modulus (K), which are directly related to c and Z. Several signal-processing algorithms exist to estimate these parameters for each scan location in a C-mode (raster scanning) configuration. Our previous studies used the most-common method, which is similar to the one described by Hozumi et al. which we term the Hozumi-based model. For measurements on thin sections of tissue, attached to a substrate (i.e., microscopy glass plate), two reflected signals occur in the recorded RF data. The first reflected signal emanates from the water-sample interface (front reflection, s₁) and the second reflected signal emanates from the sample-substrate interface (back reflection, s₂). Acoustical-parameter values (i.e., Z, c, α) are estimated by comparing the time of flight (TOF) and amplitude of s₁ and s₂ to the TOF and amplitude of a reference signal, which is obtained from a glass-plate-only reflection. Accurately decomposing the acquired RF signals into these two reflection signals is the signal-processing challenge in soft-tissue QAM applications.

In an ideal scenario, the thickness of the investigated soft-tissue section should be in the order of the available axial resolution and a fraction of the −6-dB depth of field for the following four reasons: to mitigate possible interfering signals (e.g., scattering) from inside the tissue; to prevent resolution deterioration caused by out-of-focus effects; to minimize attenuation effects; and to maintain a nearly planar wave front. However, if the sample is too thin, then the reflected signals overlap in time and frequency domains, which makes separating the signals with conventional signal-processing methods challenging. The bandwidth of a QAM system dictates the lower limit for sample thickness. Another challenge is the low amplitude of the first reflected signal, which is typical because the acoustic impedance of most soft tissues is close to that of the coupling fluid (e.g., water or saline). This problem makes detection of the first signal and correct parameter estimation difficult.

Although, our previously developed algorithms worked satisfactorily in several applications, we experienced sub-optimal acoustic-parameter estimation when analyzing signals from thin tissue samples. When using QAM systems equipped with transducers operating at 250 MHz and 500 MHz, signal-processing algorithms must reliably operate over a large range of sample thicknesses. For such dual-frequency experiments the current algorithm works best on 6-, and 12-μm thin sections when 500-MHz and 250-MHz transducers are employed, respectively. However, to directly compare measurements from both transducers, ideally the same 6-μm sections are scanned with both transducers instead of scanning adjacent slides with different thicknesses (i.e., a 6-μm and an adjacent 12-μm thin cut). Another limitation of the QAM approach is its inability to estimate non-linear attenuation. Numerous studies described in literature suggest that ultrasound attenuation in most soft tissues is best described by an exponential model as a non-linear function of frequency. In particular, at the very high frequencies employed in QAM, frequency-dependent attenuation in all the materials, including the coupling medium as well as the tissue specimen, can have a significant impact on the parameter estimation.

### SUMMARY OF THE INVENTION

Quantitative acoustic microscopy (QAM) at frequencies exceeding 100 MHz has become an established imaging tool to depict acoustical and mechanical properties of soft biological tissues at microscopic resolutions. The present invention provides a novel autoregressive (AR) model to improve signal processing and parameter estimation and to test its applicability to QAM. The performance of the present invention AR model for estimating acoustical parameters of soft tissues (i.e., acoustic impedance, speed of sound, and attenuation) is compared to the performance of the Hozumi model using simulated ultrasonic QAM-signals and using experimentally measured signals from thin (i.e., 12 and 6 μm) sections of human lymph-node and pig-cornea tissue specimens. Results showed that the AR and Hozumi methods perform similarly (i.e., produced an estimation error of 0) in signals with low, linear attenuation in the tissue and high impedance contrast between the tissue and the coupling medium. However, the AR model of the present invention outperforms the Hozumi model in estimation accuracy and stability (i.e., parameter error variation and number of outliers) in cases of (1) thin tissue-sample thickness and high tissue-sample speed of sound, (2) small impedance contrast between the tissue sample and the coupling medium, (3) high attenuation in the tissue sample and (4) non-linear attenuation in the tissue sample. Furthermore, the AR-model allows estimating the exponent of non-linear attenuation. The present invention AR-model approach improves current QAM by providing more-reliable, quantitative, tissue-property estimates, and also provides additional values of parameters related to non-linear attenuation.

The present invention provides a novel autoregressive (AR) model approach coupled with a denoising algorithm to further improve signal decomposition and parameter estimation and to test its applicability to QAM. The present invention will be referred to as the AR-based model. In addition, the performance of the AR model is compared with the Hozumi model in simulated data and experimental data from soft tissues.

A method to create a parameter map depicting acoustical and mechanical properties of biological tissue at microscopic resolutions to identify potential health related issues, including mounting the biological tissue on a substrate, raster scanning the biological tissue with an RF frequency, recovering RF echo signals from said substrate and from a plurality of locations on said biological tissue, wherein each of the plurality of locations corresponds to a specific pixel comprising the parameter map, the recovered RF echo signals including a reference signal recovered from the substrate at a point devoid of tissue, a first sample signal recovered from an interface between the biological tissue and water, and a second sample signal recovered from an interface between said biological tissue and said substrate, repeatedly applying a plurality of computer-generated calculation steps based on the reference signal, the first sample signal and the second sample signal to generate estimated values for a plurality of parameters associated with each of the specific pixels in the parameter map; wherein the plurality of computer-generated calculation steps including a denoising step, and using the generated estimated values to create said parameter map depicting parameters including, but not limited, to acoustic impedance, speed of sound, ultrasound attenuation, mass density, bulk modulus and nonlinear attenuation.

### BRIEF DESCRIPTION OF THE DRAWINGS

The patent or application filed contains at least one drawing executed in color. Copies of this patent or patent application publication with color drawing(s) will be provided by the Office upon request and payment of the necessary fee.

Further objects, features and advantages of the invention will become apparent from the following detailed description taken in conjunction with the accompanying figures showing illustrative embodiments of the invention, in which:

FIG. 1 is a diagram of the QAM approach;

FIG. 2 shows the results of parameter variation and resulting error in estimating acoustic-properties values;

FIGS. 3a-3e provides simulation results showing estimation error and standard deviation of exponent η for varying components using the NLAR model;

FIGS. 4a-4d provides simulation results showing estimation error and standard deviation for varying components for varying amplitude of the perturbation signal;

FIGS. 5a-5j shows simulated and measured signals with fit signals using the Hozumi model and the AR model;

FIGS. 6a-6h show a QAM amplitude map and parameter maps generated using the Hozumi model and the AR model;

FIGS. 7a-7f show parameter maps from RO12 of FIG. 6a generated using the Hozumi model and the AR model;

FIGS. 8a-8d show parameter maps of a human lymph node derived using the NLAR model;

FIGS. 9a-9h show an amplitude and histology map of a pig comes and parameter maps generated using the Hozumi model and the AR model; and

FIGS. 10a-10c show normalized and varied spectra of a signal.

### DETAILED DESCRIPTION

2. Theory

A. Forward Model

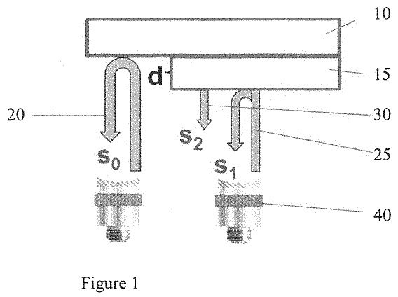

FIG. 1 depicts the experimental approach used to collect data using transducers 40 and tissue sample 15 on glass plate substrate 10. The sample is raster scanned in 2D, and RF echo signals are acquired at each scan location. The RF echo signal acquired from a location devoid of tissue is referred to as the reference signal, 20, and is symbolized by s₀(t−t₀). This notation indicates that the reference signal is composed of only one echo at the glass-water interface. Other scanned locations are referred as sample signals 25. 30, and symbolized with s₁(t) being the reflection from the sample-water interface and s₂(t) being the reflection from the sample-substrate interface. d denotes sample thickness of tissue sample 15. Table 1 below lists all symbols used to describe the theory.

Similarly, we refer to signals derived at all other scanned locations as sample signals, symbolized by s(t). Our forward model is described using the following expression:

$$\begin{matrix}s ( t ) = {s}_{1} ( t ) + {s}_{2} ( t ) + … + {s}_{n} ( t ) & ( 1 ) \\ = {C}_{1} {s}_{0}^{*} ( t - {t}_{1} ) + {C}_{2} {s}_{0}^{*} ( t - {t}_{2} ) + … + {C}_{n} {s}_{0}^{*} ( t - {t}_{n} ) , & ( 2 )\end{matrix}$$

which means that the sample signals are the sum of n weighted and delayed versions of the reference signal and the ‘*’ symbol represents frequency-dependent attenuation effects. Among these n signals, two (i.e., sₖ_{₁}, and sₖ_{₂} with k₁≠k₂ and tₖ_{₁}<tₖ_{₂}) are the echoes from the water-tissue and tissue-glass interfaces, respectively. These two signals are the ones needed to obtain quantitative tissue properties. The remaining n−2 signals (i.e., sₖ_{₃}, . . . , sₖ_{ₙ}) account for potential multiple reflections, scattering, or noise.

By taking the Fourier transform of Eq. (2), we obtain:

S(f)=S₀(f)[C₁ exp(f(β₁+j2π(t₁−t₀)))+ . . . +Cₙ exp(f(βₙ+j2π(tₙ−t₀)))], (3)

where βₖ is the attenuation coefficient of the k^{th} signal in Np/Hz and S₀(f) is the Fourier transform of the reference signal (i.e., S₀(f)=FFT(s₀)). By dividing S(f) by s₀(f) eq. (3) yields the normalized spectrum:

N(f)=S(f)/S₀(f)

=Σₖ₌₁ⁿCₖ(f[βₖ+j2π(tₖ−t₀)]) (4)

TABLE 1
Used symbols

| Symbol | Explanation |
|---|---|
| A_{M} | amplitude in mV and determined by the maximum of the |
| | envelope signal |
| α | =β₂/2d |
| βₖ | attenuation coefficient of the k^{th} signal in Np/Hz |
| Cₖ | signal amplitude |
| c, c_{w} | speed of sound in tissue and coupling medium in m/s |
| d | tissue thickness |
| η | non linear attenuation exponent in α(f) = σf^{η} |
| ϵᵢ | error term |
| F | discrete frequency index |
| f, fₘ | frequency vector, center frequency in MHz |
| Δf | =fs/(2M) where M is total duration of the sampled |
| | signal in points and fs is the sampling frequency |
| fₘᵢₙ, fₘ | frequencies of the extrema of \|N\|² |
| Γ | column vector of unknown C_{q} |
| H_{q, p} | Hankel matrix = N_{q+p-i} |
| j | complex number (i.e., j = \sqrt{−1}) |
| k | signal index |
| Λ | Vandermonde-like matrix of size n by F₂ − F₁ + 1 whose |
| | element q, p is λ_{q}^{p}, [symbol] |
| λₖ | =exp(Δf[βₖ + j2π(tₖ − t₀)]) |
| N(f) | normalized spectrum |
| n | number of signals |
| φᵤ(N) | unwrapped phase of N |
| p, q | used as integer index |
| Sₖ(f) | Fourier Transform of sₖ(t) |
| sₖ(t), s [symbol] | signal and reference signal in the time domain |
| σ | attenuation coefficient (α(f) = σf^{η}) in dB/cm |
| TOF | time of flight in μs and determined by the maximum of |
| | the envelope signal |
| t | time vector in s |
| xₖ | AR coefficients |
| Z, Z_{w}, Z [symbol] | acoustic impedance in MRayl of tissue, coupling, and |
| | glass plate, respectively |

[symbol]

indicates data missing or illegible when filed

B. Hozumi Inverse Model

The Hozumi model is compared here to the present invention AR model. Briefly, the Hozumi inverse model assumes n=2 in the forward model and implementation starts by assessing the extrema of the squared magnitude (|N|²) of the normalized spectra. From eq. (4), using n=2 and assuming β₁=0 (i.e., the first signal suffers no attenuation), following expression can be derived:

$$\begin{matrix}{\vert N \vert}^{2} = {\vert \frac{FFT \{ {s}_{1} ( t ) + {s}_{2} ( t ) \}}{FFT \{ {s}_{0} ( t ) \}} \vert}^{2} & ( 5 ) \\ = {C}_{1}^{2} + 2 {C}_{1} {C}_{2} \cdot {e}^{f {β}_{2}} \cdot cos ( 2 π f ( {t}_{2} - {t}_{1} ) ) + {C}_{2}^{2} {e}^{2 f {β}_{2}} . & ( 6 )\end{matrix}$$

Then,

$$\begin{matrix}{ϕ}_{u} ( N ) = 2 π ( {f}_{ma x} \frac{2 d}{{c}_{w}} - p ) , p ∈ ℤ & ( 7 ) \\ and & \\ {ϕ}_{u} ( N ) = 4 π {f}_{m i n} \frac{d}{{c}_{w}} - π ( 2 p - 1 ) , p ∈ ℤ & ( 8 )\end{matrix}$$

where d is the tissue thickness, fₘᵢₙ and fₘₐₓ are the frequencies of the extrema of |N|², and φᵤ(N) is the unwrapped phase of N. Eq. (7), and (8) are used to estimate the thickness of the specimen. The speed of sound (c) can be estimated using

$$d = \frac{{ϕ}_{u} ( N )}{4 π {f}_{ma x} ( \frac{1}{{c}_{w}} - \frac{1}{c} )} \qquad ( 9 )$$

where c_{w} is the speed of sound in the coupling medium. C₁, C₂ and α=β₂/2d can be found from the amplitudes of |N|². The acoustic impedance of the sample (Z) was estimated from C₁ using first principles. To estimate α we used a dichotomy method applied to |N|².

C. Autoregressive Inverse Model (AR Model)

Initially, the AR model assumes that the signals are composed of more than one signal, i.e., n is assumed to be ≥2, because that value provides robustness and stability. Most of the n decomposed signals are related to noise and estimation artifacts. The aim of this chapter is to find the two signals that are related to the water-sample and sample-substrate interfaces.

The inverse model consists of rewriting Eq. (4) at discreet frequencies denoted by fᵢ=iΔf. The step size (Δf) is related to the total duration of the sampled signal in points (M) and the sampling frequency (fs) and is defined by fs/(2M). (Note that zero-padding the signal will make Δf smaller as it is typically done, but in this application it does not provide new information and is therefore unnecessary and was not done.) Discretization yields the following equation for Nᵢ=N(iΔf):

$$\begin{matrix}{N}_{i} = {\sum }_{k = 1}^{n} {{C}_{k} [ exp ( Δ f ( {β}_{k} + j 2 π ( {t}_{k} - {t}_{0} ) ] ) ]}^{i} & ( 10 ) \\ = {\sum }_{k = 1}^{n} {C}_{k} {λ}_{k}^{i} , & ( 11 )\end{matrix}$$

where λₖ=exp(Δf[βₖ+j2π(tₖ−t₀)]).

Then, the AR process is introduced by assuming that Nᵢ can be estimated using a linear combination of the fᵢ-previous frequencies:

Nᵢ=Σₖ₌₁^{\hat{n}}xₖNᵢ₋ₖ+ϵᵢ, (12)

where ϵᵢ is an error term and the xₖ are AR coefficients and we choose \hat{n}=n.

Based on Eq. (12), the AR inverse model consists of the following four steps: 1) estimating the Cₖ and λₖ, 2) Cadzow denoising, 3) determining k₁ and k₂, and 4) estimating all acoustic parameters from Cₖ_{₁}, Cₖ_{₂}, λₖ_{₁}, and λₖ_{₂}.

1) Estimation of Cₖ and λₖ

Equation (12) is rewritten in matrix notation and only is used between frequencies f₁=F₁Δf and f₂=F₂Δf, which are determined by the −20-dB bandwidth of the transducer:

N=−RX+ϵ, (13)

where N is the column vector of length F₂−F₁−n+1 and is composed of the values of Nᵢ from F₁+n to F₂, R is the n by F₂−F₁−n+1 matrix whose element (q,p) is N_{F}_{₁}_{+n-q+p-1}, and ϵ is the column vector of length F₂−F₁−n+1 composed of the values Eq from q=F₁+n to q=F₂.

Equation (13) is solved for X using a least-squares minimization the sum of the magnitude-squared errors (i.e., ϵ^{t}ϵ, where the superscript t symbolizes the transposition operation):

X=−(R^{t}R)⁻¹(RN). (14)

Equations (10) and (12) are combined to establish a relationship between X and the λₖ:

Nᵢ=−Σₗ₌₁ⁿxᵢΣₖ₌₁ⁿCₖλₖ^{i-l} (15)

⇔−Σₖ₌₁ⁿxₖNᵢ₋ₖ=−Σₗ₌₁ⁿxᵢΣₖ₌₁ⁿCₖλₖ^{i-l}, (16)

which yields:

$${\sum }_{k = 1}^{n} {C}_{k} {λ}_{k}^{i} P ( \frac{1}{{λ}_{k}} ) = 0 , \qquad ( 17 )$$

where P is a polynomial of degree n defined by:

P(z)=1+Σₗ₌₁ⁿxₗz^{l}. (18)

Equation (17) must be true at all frequencies, thus,

$$P ( \frac{1}{{λ}_{k}} ) = 0$$

for all k. Therefore, the λₖ are the reciprocal of the n zeros of P. P(z)=0 can be easily solved because the coefficients xₗ are known through eq. (14).

To find the Cₖ, eq. (10) is written for all i between f₁ a f₂, yielding the following matrix equation:

ΛF=N₂, (19)

where Λ is a Vandermonde-like matrix of size n by F₂−F₁+1 whose element q, p is λ_{q}^{p}, Γ is a column vector of unknown C_{q}, and N₂ is a column vector whose q^{th} element is N_{F}_{₁}_{+q-1}. This equation is solved using a least-squares approach to yield:

Γ=(Λ^{t}Λ)⁻¹(ΛN₂), (20)

2) Cadzow Denoising

To improve the signal decomposition by further taking advantage of the low expected rank of R, Cadzow de-noising was applied to preprocess N and to yield a new vector N^{D}. The method makes iterative use of singular-value decomposition (SVD) and anti-diagonal averaging to reduce the rank of the Hankel matrix (H_{q,p}=N_{q+p-1}) as described briefly in the following.

The first step consists of calculating the SVD such that

H=U*S*V′. (21)

where S is a diagonal matrix with nonnegative diagonal elements (i.e., singular values) in decreasing order and U and V are unitary matrices. In the next step (Ñᵢ) is reconstructed by keeping only the n largest singular values of S

Ñᵢ=U*Sₙ*V′, (22)

where Sₙ(q,p)=S(q,p) for q, p<n and Sₙ=0 otherwise. A de-noised version (N^{D}) of N can be reconstructed by taking the average of all anti-diagonals of Ñᵢ

Nᵢ^{D}=mean_{q+p=i+1}(Ñ). (23)

Eqs. (21) to (23) are repeated iteratively (i.e., five times in QAM applications). Although we choose n>2, the aim is to find the two signals, sₖ_{₁}, and sₖ_{₂} (k₁≠k₂ and tₖ_{₁}<tₖ_{₂}, see eq. (2)), that represent the water-sample and sample-substrate reflections, respectively. Other signal components (i.e., sₖ_{₃} to sₖ_{ₙ}) either are related to noise, estimation artefacts or are actual signals originating from structures inside the tissue (e.g., caused by scattering). To simplify the parameter estimation further, we eliminated signals related to noise and estimation artifacts. To do this, we tested the following two strategies: we set n to a fixed predefined constant (e.g., n=2) or we estimated it based on a threshold procedure. We estimated n to be the K singular values that contribute more than 10% to the overall signal. During the first iteration of the Cadzow de-noising, we calculated

$$n = 1 + ‖ \{ q s . t . q \geq 1 and \frac{{S ( q , q )}^{2}}{{\sum }_{p \geq 1} {( S ( p , p ) )}^{2}} > 0.1 \} ‖ , \qquad ( 24 )$$

where ∥ ∥ represents the cardinal symbol that expresses the number of elements in the enclosed set ({ }). This approach can produce signals with higher orders (i.e., n>2). To find sₖ_{₁} and sₖ_{₂} to estimate the acoustic parameters, we applied Cadzow denoising followed by replacing N by N^{D} in eq. (10).

3) Determining k₁ and k₂

The next step of the inverse model consists of finding the indices (k₁ and k₂) corresponding to the water-tissue reflection defined by sₖ_{₁} and the tissue-glass reflection defined by sₖ_{₂}. The AR inverse model can find signals that are related to noise or artifacts and are not related to the original signal. Some of these unreliable signals easily can be identified and excluded by thresholding the signal amplitude or phase shift (i.e., tₖ−t₀). For QAM applications, we implemented a simple, but fast and efficient, algorithm to find sₖ_{₁} and sₖ_{₂}. The first step of the algorithm consists of calculating the amplitude (A_{M} in milliVolts) and time of flight (TOF_{M} in microseconds) of the maximum of the Hilbert-transformed signals. Assuming that the amplitude (Cₚ=1/\hat{R}ₚ where \hat{R}ₚ is the reflection coefficient of signal sₚ with p∈{1, . . . , n} and is estimated using eq. (40)) and time of flight (TOFₚ=tₚ−t₀, see eq. (26)) of at least one of the signals sₖ_{₁} or sₖ_{₂} must be close to A_{M} and TOF_{M} of the measured signal, the algorithm first finds the sₚ, with

p=arg minₚ(\sqrt{(A_{M}−Cₚ)²+(TOF_{M}−TOFₚ)²}). (25)

The second signal is then selected by finding the C_{q} with q=arg min_{q≠p}|A_{M}−C_{q}|. The final step consists of sorting sₚ and s_{q} so that sₚ=sₖ_{₁}; s_{q}=sₖ_{₂} if TOFₚ≤TOF_{q} and s_{q}=sₖ_{₁}; sₚ=sₖ_{₂} otherwise. This approach assumes that the two amplitudes from sₖ_{₁} and sₖ_{₂} are the two largest among the n signals of the forward model. If the amplitude from a third signal, originating from scattering or reflections from within the sample, is stronger, then Cₖ_{₁} or Cₖ_{₂} in the above algorithm will misidentify the desired signals. However, we never encountered this situation in any of our experiments in soft tissue with a glass plate as a substrate.

4) Acoustic-Parameter Estimation

The final step of the AR inverse model consists of estimating, acoustic impedance, speed of sound and attenuation from Cₖ_{₁}, Cₖ_{₂}, λₖ_{₁}, and λₖ_{₂}.

The definition of λₖ (see eq. (10)) directly yields:

$$\begin{matrix}{t}_{{k}_{1}} - {t}_{0} = \frac{imag ( log ( {λ}_{{k}_{1}} ) )}{Δ f} & ( 26 ) \\ {t}_{{k}_{2}} - {t}_{0} = \frac{imag ( log ( {λ}_{{k}_{2}} ) )}{Δ f} , & ( 27 ) \\ and & \\ {β}_{{k}_{1}} = \frac{real ( log ( {λ}_{{k}_{1}} ) )}{Δ f} & ( 28 ) \\ {β}_{{k}_{2}} = \frac{real ( log ( {λ}_{{k}_{2}} ) )}{Δ f} , & ( 29 )\end{matrix}$$

where imag and real symbolize functions that take the imaginary and real part of the argument.

First principles also lead to the following expressions:

$$\begin{matrix}{t}_{{k}_{1}} - {t}_{0} = \frac{2 d}{{c}_{w}} & ( 30 ) \\ {t}_{{k}_{2}} - {t}_{0} = \frac{2 d}{c} - \frac{2 d}{{c}_{w}} , & ( 31 )\end{matrix}$$

which can be simultaneously solved to yield:

$$\begin{matrix}d = \frac{{c}_{w}}{2} \frac{imag ( log ( {λ}_{{k}_{1}} ) )}{Δ f} & ( 32 ) \\ c = {c}_{w} \frac{imag ( log ( {λ}_{{k}_{1}} ) )}{imag ( log ( {λ}_{{k}_{1}} ) ) + imag ( log ( {λ}_{{k}_{2}} ) )} , & ( 33 )\end{matrix}$$

To estimate Z, we exploit the fact that Cₖ_{₁} is the ratio between the pressure reflection coefficients at the water-tissue and at the water-glass interfaces (i.e., R_{wt} and R_{wg}, respectively).

$${C}_{{k}_{1}} = \frac{{R}_{wt}}{{R}_{wg}} = \frac{Z - {Z}_{w}}{Z + {Z}_{w}} \frac{{Z}_{g} + {Z}_{w}}{{Z}_{g} - {Z}_{w}} \qquad ( 34 )$$

which yields

$$Z = {Z}_{w} \frac{1 + \frac{{C}_{{k}_{1}}}{{R}_{wg}}}{1 - \frac{{C}_{{k}_{1}}}{{R}_{wg}}} . \qquad ( 35 )$$

In eq. (34) and eq. (35), Z_{w} and Z_{g} stands for the known acoustic impedance of water and glass, respectively.

To estimate the attenuation, we note that βₖ_{₂} is the attenuation coefficient suffered by the signal through round-trip travel into a tissue that has a thickness of d, therefore,

$$α = \frac{{β}_{{k}_{2}}}{2 d} = \frac{real ( log ( {λ}_{{k}_{2}} ) )}{2 d Δ f} , \qquad ( 36 )$$

which is then converted to dB/cm/MHz.

First principles also provide an estimate of Z based on Cₖ_{₂} using

$${C}_{{k}_{2}} = \frac{2 Z}{{Z}_{w} + Z} \frac{{Z}_{g} - Z}{{Z}_{g} + Z} \frac{2 {Z}_{w}}{{Z}_{w} + Z} \frac{{Z}_{w} + {Z}_{g}}{{Z}_{w} - {Z}_{g}} , \qquad ( 37 )$$

which results because the tissue-glass echo propagates from water to tissue, reflects at the glass-tissue interface, and propagates back from tissue to water. The last term in Eq. (37) also appears in Eq. (34) from the division by S₀ and is the reciprocal of the water-glass pressure reflection coefficient.

Equation (37) can be rewritten as

δZ³+[δ(2Z_{w}+Z_{g})+1]Z2+[δ(Z²_{w}+2Z_{w}Z_{g})−Z_{g}]Z+δZ_{w}²Z_{g}=0, (38)

where

$$δ = {Ck}_{2} \frac{{Z}_{g} - {Z}_{w}}{4 {Z}_{w} ( {Z}_{g} + {Z}_{w} )} . \qquad ( 39 )$$

Equation (38) is a third-degree polynomial which is solved using closed-form equations to provide three roots. Typically, finding the correct root is straightforward because the correct root is close to the acoustic impedance value of water. One of the other two roots is usually smaller than one MRayl and the last one greater than three MRayl.

Initial tests with measured signals showed in some cases that the attenuation βₖ_{₁} for the first signal (sₖ_{₁}), which originates only from ultrasound paths in water (see FIG. 1), is not negligible (i.e., βₖ_{₁}≠0). Hence, assuming that attenuation in water is negligible at frequencies of 250-MHz and higher can lead to an inaccurate estimate of the acoustic impedance (Z). To obtain an attenuation-corrected estimate of the first signal amplitude (i.e., Ĉₖ_{₁}), we used

$${\hat{C}}_{{k}_{1}} = {C}_{{k}_{1}} {\vert {λ}_{{k}_{1}} \vert}^{\frac{fm}{Δ f}} = {C}_{{k}_{1}} exp ( {β}_{{k}_{1}} {f}_{m} ) , \qquad ( 40 )$$

where fₘ is the center frequency of the transducer. Equation (40) is used to correct the amplitude of the first signal for a potentially negative value of βₖ_{₁} by providing a corrected value at the center frequency. Ĉₖ_{₁} is then used instead of Cₖ_{₁} to estimate Z in eq. (35) (Note that because ĈRₖ_{₁}=Cₖ_{₁} when βₖ_{₁}=0, eq. (40) is always used.)

D. Nonlinear Autoregressive (NLAR) Inverse Model

This describes a refinement of the AR inverse model in the case of acoustic attenuation that is not linear with frequency.

1) Affine Attenuation

We start from the following approximation for attenuation:

α(f)=α₀+α₁f, (41)

where α₀ is not equal to zero as assumed above. In this case, simple algebraic manipulations can be used to estimate α₀ and to establish that α₁ can be estimated using eq. (36) because

$$\frac{{C}_{{k}_{2}} {S}_{{k}_{2}} ( f )}{{S}_{0} ( f )} \\ \begin{matrix}= {C}_{{k}_{2}} exp ( 2 π f ( {β}_{{k}_{2}} + j ( {t}_{{k}_{2}} - {t}_{0} ) ) ) \\ = {C}_{{k}_{2}} exp ( 2 π [ 2 d ( {α}_{0} + {α}_{1} f ) ] + 2 π fj ( {t}_{{k}_{2}} - {t}_{0} ) ) \\ = {C}_{{k}_{2}} exp ( 2 π [ 2 d {α}_{0} ] ) exp ( 2 π f ( 2 d {α}_{1} + 2 π fj ( {t}_{{k}_{2}} - {t}_{0} ) ) ) \\ = {C}_{{k}_{2}}^{*} exp ( 2 π f ( {β}_{{k}_{2}}^{*} + j ( {t}_{{k}_{2}} - {t}_{0} ) ) ) ,\end{matrix} \qquad ( 42 )$$

where

Cᵢ_{₂}*=Cᵢ_{₂} exp(2π[2dα₀]) (43)

βᵢ_{₂}*=2dα₁. (44)

Therefore, Eq. (44) confirms that α₁ can be directly obtained from Eq. (36). To obtain α₀, we use Eq. (37) with the value of Z found from Eq. (35) to obtain Cᵢ_{₂}. Because of the identity of Eq. (42), Eq. (20) yields Cᵢ_{₂}*. Equation (43) then can estimate α₀.

2) Power-Law Attenuation

Finally, although the affine law of Eq. (41) is often used to obtain an attenuation approximation when attenuation values are known over a finite bandwidth, in this final section, we consider the power-law model of attenuation as expressed by:

α(f)=σf^{η}, (45)

To estimate σ and η, we use the affine approach over m distinct frequency bandwidths (i.e., BW₁∈{BW₁, BW₂, . . . , BWₘ}) that are composed of frequencies BWₗ=f₁¹, . . . , f_{N}_{₁}¹, BW₂=f₁² . . . , f_{N}_{₂}², . . . , BWₘ=f₁^{m}, . . . , f_{N}_{ₘ}^{m}. This procedure yields α₀^{l} and α₁^{l} where the superscript l specifies which bandwidth was used to obtain these estimates. Then, we derive the following equations for all f^{l} included in each BW:

log(σ)+η log(f^{l})=log(α₀^{l}+α₁^{l}f^{l}), (46)

which can be written in the following matrix form:

M[log(σ),η]=T, (47)

where

$$M = ( \begin{matrix}1 & log ( {f}_{1}^{1} ) \\ ⋮ & ⋮ \\ ⋮ & log ( {f}_{{N}_{1}}^{1} ) \\ ⋮ & ⋮ \\ ⋮ & log ( {f}_{1}^{m} ) \\ ⋮ & ⋮ \\ 1 & log ( {f}_{{N}_{m}}^{m} )\end{matrix} ) ; T = ( \begin{matrix}log ( {α}_{0}^{1} + {α}_{1}^{1} {f}_{1}^{1} ) \\ ⋮ \\ log ( {α}_{0}^{1} + {α}_{1}^{1} {f}_{{N}_{1}}^{1} ) \\ ⋮ \\ log ( {α}_{0}^{m} + {α}_{1}^{m} {f}_{1}^{m} ) \\ ⋮ \\ log ( {α}_{0}^{m} + {α}_{1}^{m} {f}_{{N}_{m}}^{m} )\end{matrix} ) ; \qquad ( 48 )$$

which is solved using a least-squares matrix formulation to obtain σ (from log(σ)) and η.

In the current implementation, we used three bandwidths (i.e., m=3): BW1 was the full −20-dB bandwidth of the transducer extending from f1 to f2 (i.e., the same as used in the AR approach), BW2 extended from f1 to f2−1/11(f2−f1), and BW3 extended from f1 to f2−2/11(f2−f1).

We limit our presentation below of results of the NLAR approach only to results obtained using the power-law attenuation model. Therefore, the NLAR approach always is discussed in terms of the the power-law attenuation method described in the present section.

3. Material and Methods

A working QAM system has been designed, fabricated, tested, and applied operating at frequencies ranging from 100 to 500 MHz and, although all the methods described in the Section II above are applicable over a wide range of frequency, the remaining discussion pertains to the QAM system discussed and equipped with a broadband transducer operating a center frequency of 250 MHz.

TABLE 2
Simulated parameter variation

| Parameter | Lower value | Step size | Upper value |
|---|---|---|---|
| SNR [dB] | 40 | 10 | 100 |
| d [μm] | 3 | 1 | 8 |
| Z [MRayl] | 1.51 | 0.01 | 1.6 |
| σ [dB/MHz/cm] | 8 | 1 | 13 |
| η | 1 | 0.1 | 1.5 |

A. Simulations

Simulations have been conducted to evaluate performance of the inverse models. To mimic our experiments closely, we used a measured reference signal obtained using the apparatus described in section 111.2 below. Simulations consisted of setting values for d, c, Z, η, and σ and reconstructing the simulated signal s^{Sim}(t) accordingly:

s^{Sim}(t)=C₁s₁^{Sim}(t)+C₂s₂^{Sim}(t)+Cₚₑᵣₜs₀*(tₜ_{ₚ}ₑᵣₜ)+Θ(t), (49)

where the first two terms are the simulated reflections from the water-tissue and tissue-glass interfaces whose defining parameters are obtained directly from the set parameters. The third term is a “perturbation” term having a shape similar to the first two terms, which can be turned off by selecting Cₚₑᵣₜ=0. The last term is a white Gaussian noise of power Θ² with

Θ=10^{(20 log} ^{₁₀}^{((ζ(s}^{₀}^{)-SNR)/20))}; (50)

where SNR is the signal-to-noise ratio expressing the difference in dB between the amplitudes of the reference signal and noise. The symbol (expresses the maximum of the hilbert transform of s₀. Equation (49) depends on a very large number of parameters; therefore, we limited the range of parameter variations to experimentally-relevant values. We tested the effects of decreasing the SNR, decreasing the signal separation (i.e., sample thickness, d), decreasing the amplitude of the first signal (i.e., acoustic impedance, Z), increasing the attenuation coefficient (i.e., σ, see eq. (45)), and increasing the frequency exponent (η). Table 2 gives a summary of all parameter-value ranges used in the simulations. These ranges were selected to be representative of realistic scenarios for QAM-applications and were based on preliminary tests to find the optimal range between easily separable cases (i.e., large SNR, d, Z, small σ and η=1) and difficult cases (i.e., small SNR, d, Z, large σ and η>1). In each simulation scenario, the value of the parameter under investigation was varied and all the remaining parameter values were kept constant with SNR=60 dB, d=8 μm, Z=1.63 MRayl, c=1600 m/s σ=10 dB/cm at 250 MHz, Cₚₑᵣₜ=0 and η=1. To assess statistical variations, each case was performed for 200 realizations of [symbol] (t). This procedure required (7+6+10+6+6)*200=7000 simulations.

To investigate the impact of a third signal, we varied Cₚₑᵣₜ from 0·Cₛ_{₁} to 0.9·Cₛ_{₁} (increment 0.1·Cₛ_{₁}) and randomly placed the third signal between s₁ and s₂ (i.e., t₁≤tₚₑᵣₜ≤t₂). This procedure ensured that Cₚₑᵣₜ was always smaller then Cₛ_{₁} and Cₛ_{₂}. The other acoustic parameter values were kept constant at SNR=60 dB, d=8 μm, Z=1.63 MRayl, c=1600 m/s σ=10 dB/cm.

To assess the performance of the inverse models, we calculated the mean error and standard deviation of estimated parameters (i.e., c, Z, α, σ and η) with the simulated parameter. In addition, we used the Grubb's test to detect and report outliers in terms of percentages to provide another metric to compare the performance of the AR- and Hozumi-model approaches in the simulation experiments.

B. Experiments

The inverse models were tested using experimental data, which were collected with our previously described 250-MHz QAM system. The device was equipped with a 250-MHz transducer and signals were digitized at 2.5 GHz with 12-bit accuracy. The data were acquired from a 12-μm thin human lymph node and a 6-μm thin section of a human cornea. The thickness of the samples was chosen to be thin enough that scattering effects are strongly mitigated. The specimens were raster scanned in 2D with a 2-μm step size in both directions. RF were data acquired at each location and processed individually using the inverse models. 2D maps of d, c, Z, and attenuation were generated. Adjacent 3-μm thin section were stained with H&E and digitally imaged at 20× to provide a reference for tissue microstructure. Outliers in experimental data were detected by using absolute thresholds for values of c and Z parameters because the Grubb's test could not be applied. Thresholds were selected based on results of our previous studies. Specifically, estimates were rejected if c<1500, c>2200, Z<1.48, or Z>2.2.

4. Results

A. Simulations

1) General Simulations

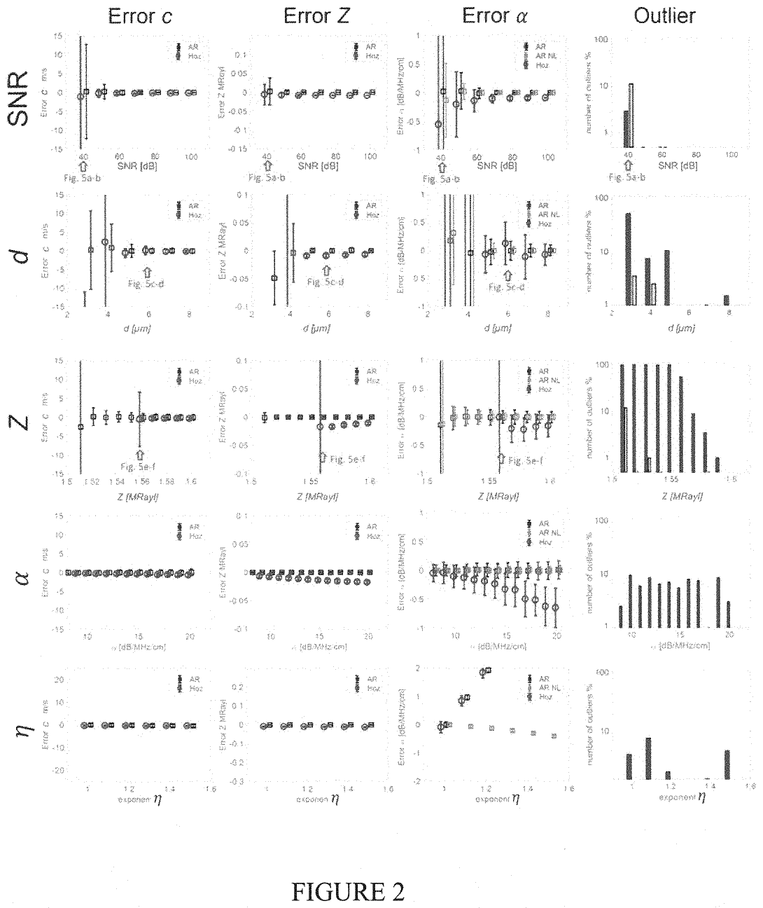

FIG. 2 shows the results of parameter variation and resulting error in estimating acoustic-properties values, which are c (i.e., column 1), Z (i.e., column 2), and α (i.e., column 3). Column 4 shows the percentage of outliers for each model.

Columns one to three of FIG. 2, show error of the estimated acoustic property (i.e., Speed of Sound (c), Acoustic Impedance (Z), and Attenuation coefficient (α)). Each row shows different parameter-set variations for signal to noise ratio (SNR), separation (i.e., d, thickness of the specimen), amplitude of the first signal (i.e., Z), attenuation coefficient (i.e., α), and attenuation exponent (i.e., η). Blue error bars show error and std of Hozumi-based estimation and black bars show error and std of AR-based estimation. Gray bars show results if a is estimated using the non linear estimation procedure (see eq. 42). The fourth column shows the outliers that in % that were removed from the parameter estimation. Mean and standard deviations were obtained after outliers were removed. Blue and gray bars show results for Hozumi and AR model, respectively.

The inverse AR and Hozumi models performed well (i.e., average errors were approximately zero for all three properties and small number of outliers) in the “easy” cases (i.e., large SNR, d, and Z and small σ and η=1). Both methods were stable in estimating c, Z, and a down to 50-dB SNR, which is lower than values found in our measurements (i.e., an SNR˜60 dB was obtained in an experimental water-glass reflection signal).

However, in the harder cases, variance, bias, and the number of outliers, of the Hozumi model were significantly greater than those of the AR model. This difference in the performance of the two inverse models is particularly, apparent for less-separated signals (i.e., variation in d, second row FIG. 2) and for small amplitudes of the first signal (i.e., variation of Z, third row FIG. 2). The Hozumi model is unable to estimate c and Z when d is smaller than 6 μm and Z is smaller than 1.56 MRayl. (In FIGS. 2-4 the absence of a data-point and error bars indicate 100% outlier as shown in column 4, i.e., the two parameters could not be estimated and the two signals could not be detected in all 200 cases). The AR model remains stable (i.e., c has an average error of ˜0 m/s and Z has an average error of ˜0 MRayl and the variation in c is <10 m/s and in Z is <0.05 MRayl) down to a d of 4 μm and a Z of 1.52 MRayl.

Simulated variations in a had a limited impact on estimates of c and Z (fourth row of FIG. 2), although the Hozumi model showed a trend toward increasing negative bias in c and Z when α increases. In addition, results clearly indicate that the NLAR and AR models significantly outperform the Hozumi model in estimating α. The simulation results also indicate that the NLAR model yielded smaller variance (even though the simulated attenuation was linear). Furthermore, the AR and NLAR models did not produce any outliers, whereas the Hozumi model produced an average outlier percentage of approximately 7%.

2) Nonlinear Attenuation Results

Simulating nonlinear attenuation (i.e., η>1) had no impact on estimates of c and Z (last row of FIG. 2) obtained using the AR and Hozumi models. However, an important impact on estimating α was visible with the Hozumi and AR models showing a strongly increasing positive bias when η increased. However, when α was estimated using a power-law model for attenuation estimation (see eq. (45)) the NLAR model produced satisfactory estimates of α up to η=1.4.

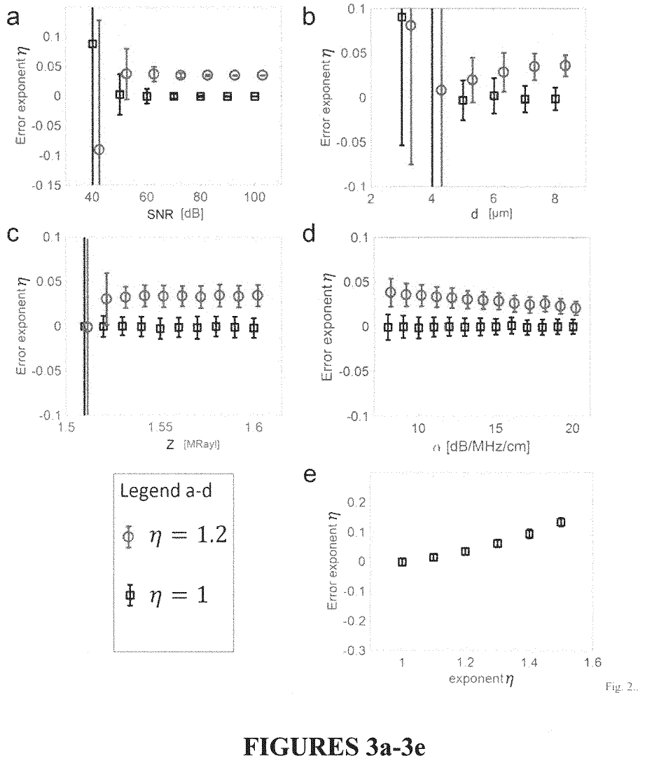

To investigate the NLAR model performance further, FIGS. 3a-d shows errors in η estimates as a function of simulated SNR, d, Z, and α, respectively η=1 (black) and η=1.2 (red). The results obtained for η=1 indicate that the NLAR model was capable of performing satisfactorily of estimating η up to an SNR of 50 dB, d=5 μm, Z=1.52 MRayl, α=20 dB/MHz/cm. Similarly, results obtained for η=1.2 were nearly identical in terms of variance, but a small positive bias of 0.05 was observed in most cases.

FIG. 3 provides simulation results showing estimation error and std of exponent η for varying parameters using the NLAR model. FIG. 3a shows SNR, FIG. 3b shows d, FIG. 3c shows Z, FIG. 3d shows α, and η using the NLAR-model.

FIG. 3e shows errors in estimates of η as a function of simulated η from 1 to 1.5. Results indicate very small variances (i.e., <0.02); however, a slowly increasing positive bias occurs as the simulated value of η increases up to a maximum bias of 0.13 when the simulated η was 1.5.

3) Perturbation-Signal Results

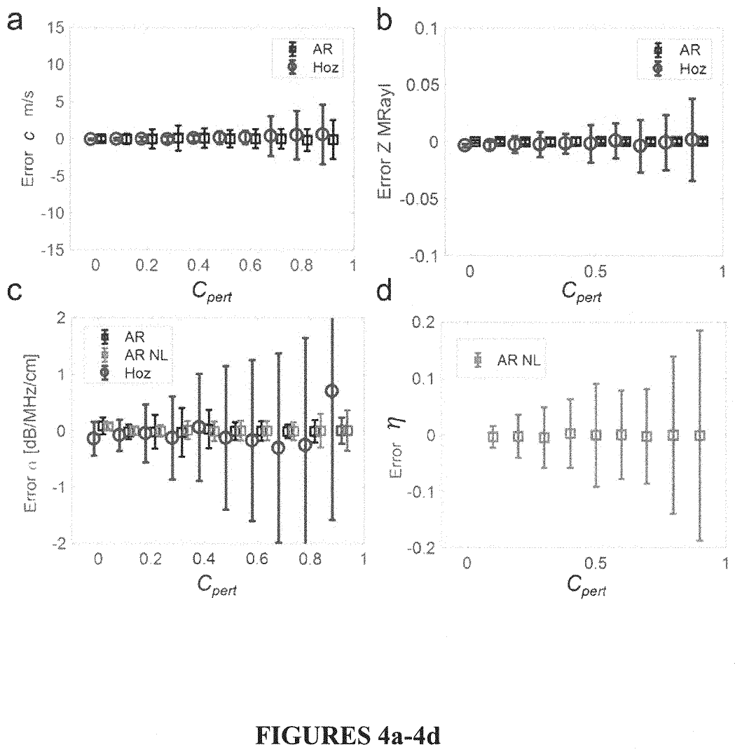

Estimation results based on simulations that included a perturbation signal showed that, as the amplitude of the perturbation signal increased, estimation errors increased for all four parameters and for all models as shown in FIGS. 4a-4d. (Estimation error and std of c (4a), Z (4b), α (4c), and exponent η (4d) for varying amplitude of the perturbation signal (Cₚₑᵣₜ)).

However, the AR-model outperformed the Hozumi model. Nevertheless, the impact of a perturbation signal on estimates of c and Z was small (FIGS. 4a and 4b) with nearly no bias and with standard deviations smaller than 5 m/s and 0.05 MRayl for all models. The error in Z was nearly zero for all tested amplitudes of Cₚₑᵣₜ when the AR model was used, whereas it increased with Cₚₑᵣₜ when the Hozumi model is used.

The existence of a perturbation signal had an important effect on estimates of α and η (FIG. 4c-4d). For a, the AR models (i.e., NLAR and AR) significantly outperformed the Hozumi model. In fact, the error bars shown in FIG. 4c in the case of the Hozumi model were greater than 0.5 dB/MHz/cm if Cₚₑᵣₜ was greater than 0.2, essentially making the α estimates unreliable. Finally, η estimates obtained using the NLAR model showed an overall trend toward increasing variance as Cₚₑᵣₜ increased, but the variances remained below 0.1 up to Cₚₑᵣₜ=0.7 except for the outlier result obtained for Cₚₑᵣₜ=0.6.

In summary, the existence of a perturbation signal has limited effects on estimates of c and Z, but strong effects on attenuation parameters. Overall, the AR and NLAR models perform much better than the Hozumi model by producing much smaller variances and more-reliable α estimates for nearly all values of Cₚₑᵣₜ

4) Illustrative Simulation Fits

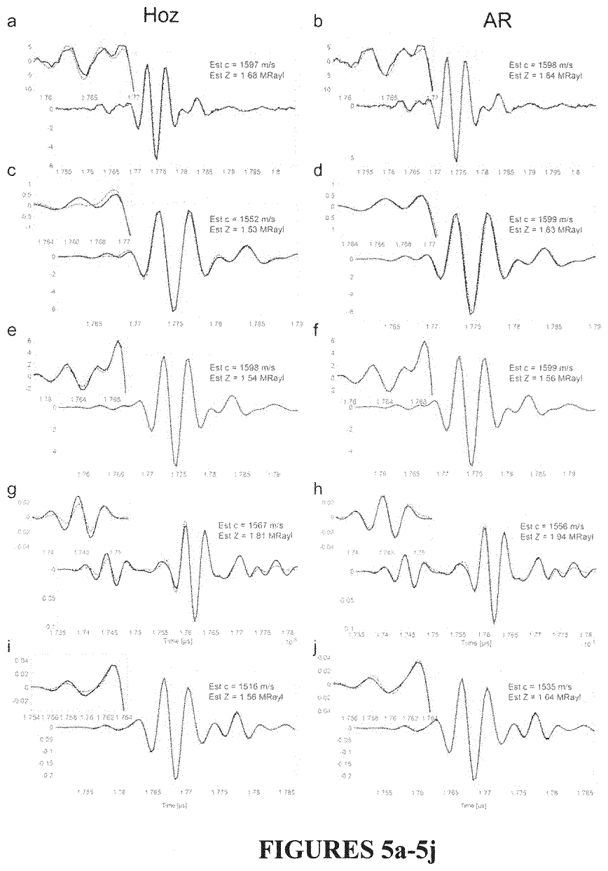

FIGS. 5a-5j show representative simulated and fitted signals (FIG. 5a-f) using the Hozumi and AR-inverse models, respectively. The depicted signals are for representative cases of the parameter-variation experiments with SNR=50 dB (FIGS. 5a-5b), d=6 μm (FIGS. 5c-5d) and Z=1.56 MRayl (FIGS. 5e-5f). These cases were selected at thresholds where the Hozumi or AR models start to fail more frequently (as illustrated in FIG. 2 rows one to three). Both models show moderately good fits even in the low SNR case (FIGS. 5a-5b). However, the AR model shows a smaller estimation error, in particular for the more-challenging case with a small sample thickness (i.e., d=6 μm, FIGS. 5c-5d). Although the fit looks reasonable, the errors in estimating Z and c are 25% and 16% of an assumed natural variations of 1.5 to 1.9 MRayl and 1500 to 1800 m/s in soft biological tissues, respectively. Similar results were observed for the variations in signal amplitude (FIGS. 5e-5f) with an underestimation of Z.

FIGS. 5a-5f show simulated signals and FIGS. 5g-5h show measured signals (i.e., depicted in black) together with the fitted signals (i.e., depicted by red dotted lines) using Hozumi model (i.e., FIGS. 5a,5c,5e,5g and 5i) and AR model (i.e., FIGS. 5b,5d,5f,5h and 5j), respectively. FIGS. 5a and 5b show a signal with a low SNR (i.e., simulated SNR=40 dB, c=1600 m/s, Z=1.63 MRayl, d=8 μm), FIGS. 5c and 5d show a signal with small d (i.e., simulated d=6 μm, c=1600 m/s, Z=1.63 MRayl), FIGS. 5e and 5f show a signal with small Z (i.e., Z=1.56 MRayl, c=1600 m/s, d=8 μm), FIGS. 5g and 5h show a measured signal of the Lymph node sample, and FIGS. 5i and 5j show a measured signal from the cornea sample. Estimated parameters of the signals are given in the figures upper right cornea.

B. Experiments

1) Lymph-Node Results

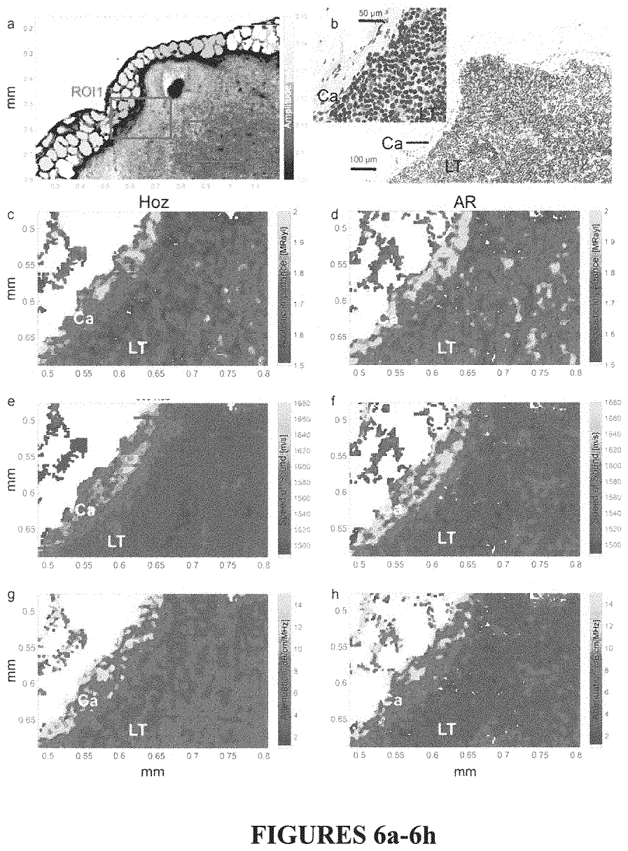

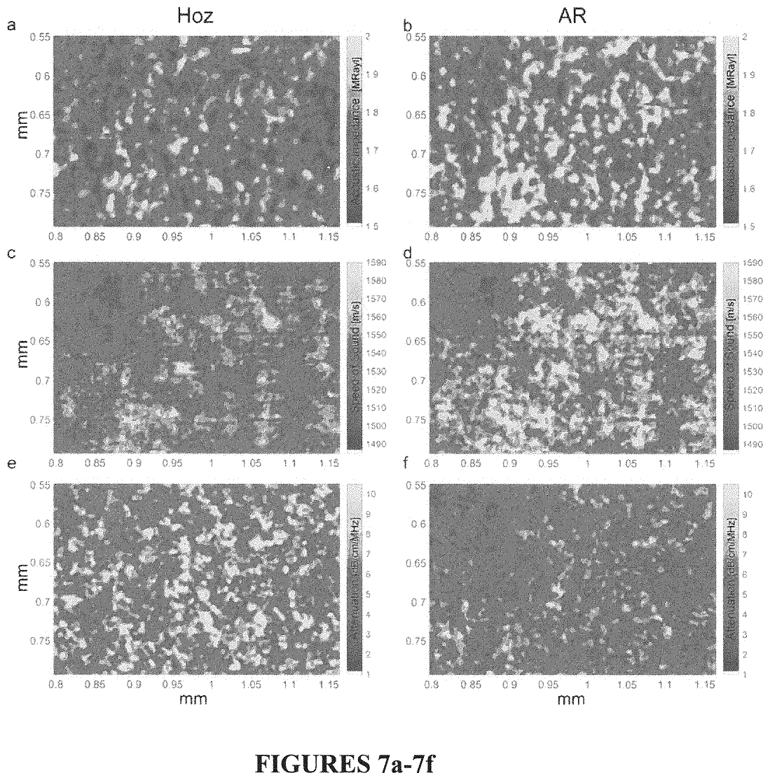

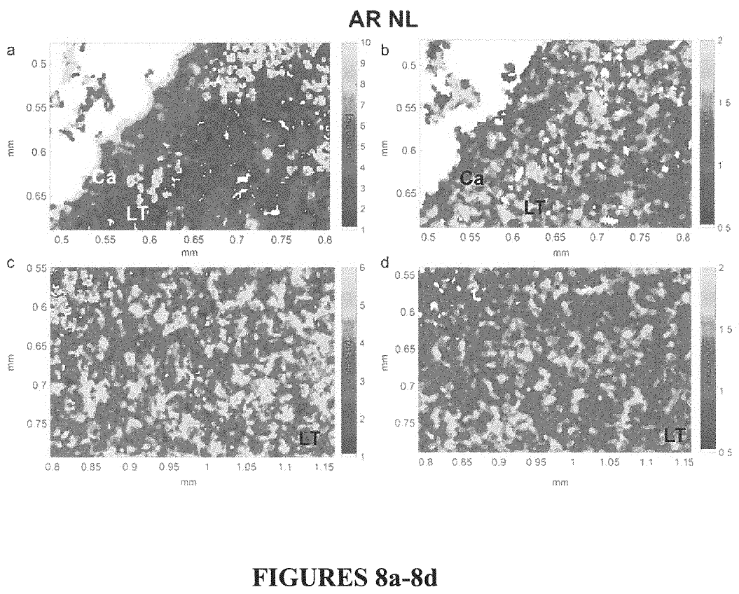

FIG. 6-8 depict parameter maps of a 12-μm lymph-node section. Parameter maps obtained with both models show similar features and allow distinguishing between different tissue types (i.e., fibrous tissue of the capsule, Ca, and lymph-node parenchyma tissue, LT). For example, Z, c, and α values were significantly higher in Ca compared to LT (T-test, p<0.01). Table 3 below summarizes average values for Ca and LT estimated using Hozumi and AR models. Average values of c and Z estimated with the Hozumi model are slightly lower than those estimated using the AR-model. On average, α values are higher when estimated with the AR model. However, all differences are within the standard deviations of the parameter variations. Differences are apparent in the structural features. In particular, the variation of c (FIGS. 6e-6f and FIGS. 7c-7d) is more noticeable in images based on the AR model than those based on the Hozumi model, and the images based on the AR model more clearly depict anatomic structures matching those visible in the histology images (FIG. 6b). Note that QAM parameter maps and H&E stained images are obtained from adjacent but different sides, which can result in dissimilarities between H&E and QAM images. The color maps in FIG. 6a-6h are optimized to highlight features in the fibrous tissue of the Ca and FIGS. 7a-7f optimizes the color maps to compare Hozumi and AR-model in LT. No difference in the number of outliers was observed between Hozumi and AR-model. Parameter maps of σ and η generated using the NLAR model are shown in FIGS. 8a-8d. The contrast between Ca and LT is weak for σ. Values for η show no significant difference between Ca and LT.

TABLE 3
Acoustic parameters of lymphocyte tissue (LT) and capsule (Ca) of
lymph nodes and epithelial (Ep) and stroma (St) tissue of cornea
samples estimated using the Hozumi and the AR model, respectively

| Parameter | Hozumi | AR/NLAR |
|---|---|---|
| Z_{LT} [MRayl] | 1.71 ± 0.09 | 1.76 ± 0.10 |
| c_{LT} [m/s] | 1541 ± 12 | 1547 ± 15 |
| α_{LT} [dB/MHz/cm] | 6.4 ± 1.4 | 5.7 ± 1.0 |
| σ_{LT} [dB/MHz] | | 3.9 ± 1.6 |
| η_{LT} | | 1.32 ± 0.22 |
| Z_{Ca} [MRayl] | 1.78 ± 0.08 | 1.84 ± 0.08 |
| c_{Ca} [m/s] | 1598 ± 21 | 1610 ± 30 |
| α_{Ca} [dB/MHz/cm] | 9.5 ± 2.7 | 8.5 ± 2.5 |
| σ_{Ca} [dB/MHz] | | 5.9 ± 2.8 |
| η_{ca} | | 1.37.± 0.21 |
| Z_{Ep} [MRayl] | 1.58 ± 0.03 | 1.59 ± 0.03 |
| c_{Ep} [m/s] | 1526 ± 20 | 1548 ± 22 |
| α_{Ep} [dB/MHz/cm] | 2.4 ± 1.5 | 3.0 ± 1.1 |
| σ_{Ep} [dB/MHz] | | 2.3 ± 1.1 |
| η_{Ep} | | 1.25 ± 0.15 |
| Z_{St} [MRayl] | 1.55 ± 0.01 | 1.55 ± 0.03 |
| c_{St} [m/s] | 1604 ± 38 | 1684 ± 60 |
| α_{St} [dB/MHz/cm] | 3.8 ± 1.8 | 6.6 ± 2.8 |
| σ_{St} [dB/MHz] | | 7.6 ± 3.4 |
| η_{St} | | 1.0 ± 0.5 |

FIGS. 6a-6h show QAM-amplitude maps derived from the maximum amplitude of the envelope signals (FIG. 6a) and H&E stained Histology map (FIG. 6b) of a human lymph node. FIGS. 6c,6e, and 6g show parameter maps generated using the Hozumi model and FIGS. 6d,6f, and 6h show parameter maps generated using the AR model. FIGS. 6c and 6d plot Z, FIGS. 6e and 6f plot c, and FIGS. 6g and 6h show α. Two tissue types are identified on the histology section, which are capsule (Ca) and Lymphocyte tissue (LT). FIGS. 6c to 6h are from ROI1.

FIGS. 7a, 7c and 7e show parameter maps from ROI2 of FIG. 6a generated using the Hozumi model and FIGS. 7b,7d, and 7f show parameter maps generated using the AR model. FIGS. 7a and 7b plot Z, FIGS. 7c and 7d plot c, and FIGS. 7e and 7f show α. The depicted tissue type is Lymphocyte tissue.

FIGS. 8a-8d show parameter maps of σ (FIGS. 8a and 8c) and η (FIGS. 8b and 8d) of a human lymph node of ROI1 (FIGS. 8a and 8b) and ROI2 (FIGS. 8c and 8d) of FIG. 6a derived using the NLAR-model.

2) Cornea Results

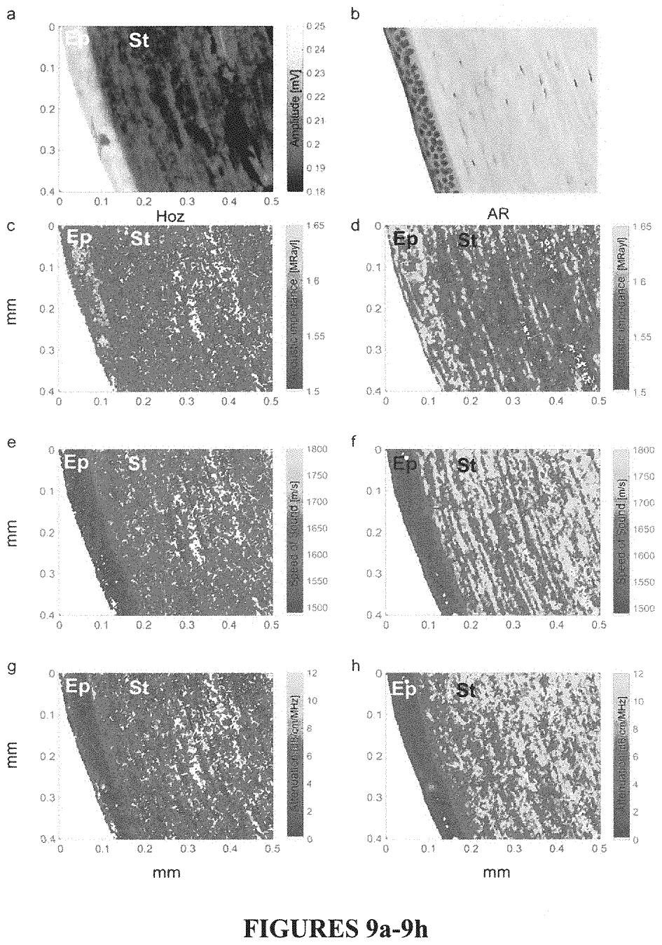

The parameter maps of the 6-μm cornea sample are shown in FIGS. 9a-9h and the average values are summarized in Table 3 above. Two tissue types (i.e., epithelium or Ep, and stroma or St) were identified with both models. Differences in acoustic properties and structural contrast between Hozumi and AR-model are evident. They are particularly apparent in St. The AR model shows higher c, Z, and α values. Furthermore, the features follow the collagen-fiber orientation as seen in the H&E stained Histology image (FIG. 9b) and the Hozumi model failed in additional locations (i.e., white areas in the parameter map) compared to the AR model. The values of c, Z, and α in the epithelium are only slightly lower in the Hozumi-based estimates.

FIG. 9a shows an amplitude map and FIG. 9b shows a histology map of a pig cornea. FIGS. 9c,9e, and 9g show parameter maps generated using the Hozumi model and FIGS. 9d,9f, and 9h show parameter maps generated using the AR model. FIGS. 9c and 9d plot Z, FIGS. 9e and 9f plot c, and FIGS. 9g and 9h show α. Two tissue types are identified on the histology section, which are epithelium (Ep) and stroma tissue (St).

3) Illustrative Experimental Fits

Above findings are confirmed by comparing the fitted models with the measured signals as shown in FIGS. 5g-j. The fitted amplitudes of the first signals (i.e., reflections from the tissue-water interface) are underestimated when the Hozumi model is used, which leads to lower estimated Z values. Lower Z values were also observed in experimental results (FIG. 6 e-f and FIG. 7 c-d), and the number of outliers was significantly higher in the thin cornea samples (white pixels in FIGS. 9c, e, and g). Furthermore, simulations suggest that non-linear attenuation (i.e., η>1) can cause an overestimation of a if the Hozumi model is used, as shown in FIG. 2 column 3 and row 5. The experimental data show η-values larger than 1 for Ca and LT (see Table 3). The Hozumi model shows higher attenuation values compared to the average α values obtained using the AR model. However, the St tissue showed an η value of approximately 1 and in this case, attenuation estimated with the AR model was almost twice as high when compared to the Hozumi model.

C. Results Summary

Overall, experiment and simulation results are consistent. For challenging cases (e.g., small d, small Z, or large α), the Hozumi model underestimates Z (FIG. 2 column 2 and rows 2 to 3) and the percentage of outliers is larger than that of the AR-model (FIG. 2 column 4, rows 2 to 3). Simulations and experimental results show that both methods perform equally well in well separated signals with low, linear attenuation and high Z contrast between the tissue and the coupling medium. However, the AR model outperforms the Hozumi model in terms of parameter-estimation accuracy and stability (i.e., parameter error variation and number of outliers) if (i) the signals overlap (e.g., because of small sample thickness or high c), (ii) the contrast in Z between the tissue and the coupling medium decreases (i.e., smaller amplitude of the first signal), (iii) the attenuation increases, and (iv) in case of non-linear attenuation (i.e., η>1).

V. Discussion and Conclusion

In this study, we investigated the application of an autoregressive inverse model for estimating acoustical properties of thin, soft-tissue sections at microscopic resolutions. In addition, our extension to better deal with power-law attenuation and the elegant use of Cadzow denoising have never been investigated and provide significant improvements in QAM imaging. The proposed AR model is similar to Prony's method, which was successfully applied in ultrasound research to separate fast and slow waves as observed in ultrasound through-transmission experiments of bone specimens. Furthermore, the inversion method used to obtain the modes of the AR process based on the zeros of a polynomial (see. Eq. (18)), also exists in signal-processing literature and is often termed annihilating filter or polynomial and has applications in sparsity-based methods.

The AR and Hozumi model are ultrasound-frequency-spectrum approaches. However, time-domain methods were also suggested in SAM and QAM applications and work well when the two signals are completely separated in time. However, the spectral methods (e.g., Hozumi, AR, cepstrum) are the only methods available to separate the two signals when they overlap in time. In fact, our results (FIG. 2, and FIGS. 5a-5j) demonstrate that the AR approach is far superior when the signals overlap significantly.

The most widely-used inverse methods for QAM-based thin-section assessment remain those based on the approach suggested by Hozumi et al. However, the Hozumi approach has limitations. For example, it only models order-two signals, strongly depends on the transducer bandwidth, relies on peak detection in the frequency domain, and does not allow estimating non-linear attenuation. Therefore, the motivation of the present invention was to improve performance for tissues with (i) acoustic impedance close to water (i.e., signals with small amplitudes and low SNR), (ii) strongly overlapping signals, (iii) high attenuation, and (iv) non-linear attenuation. Our simulation results show better performance (e.g., a smaller parameter-estimation error) and better stability (e.g., a smaller variation of estimation error and fewer outliers) for our AR-inverse model approach in all four investigated cases (FIG. 2) when compared to the Hozumi approach. Particularly relevant to soft-tissue measurements is the better performance of the AR model when Z is close to the impedance of water (i.e., when the amplitude of the first signal is small and the SNR is low). Furthermore, in very thin sections that produce overlapping signals, the AR-model is more stable. This feature is a very important attribute for soft-tissue measurements because it allows performing acoustic microscopy and optical microscopy on the same sample without sacrificing histology-image quality caused by thick samples.

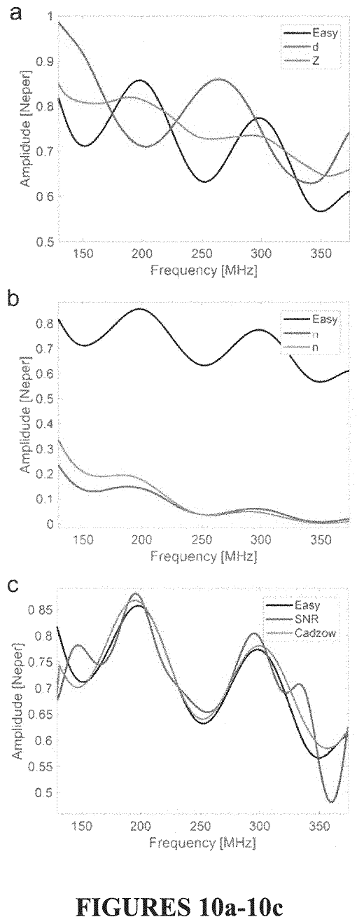

Interestingly, the present invention provides that non-linear attenuation in ranges typical for soft tissues has only a small impact on c and Z estimates for the Hozumi and AR models. The Hozumi-model shows only a small bias for Z estimates with increasing attenuation. Nevertheless, the Hozumi-inverse model has difficulties estimating α with increasing attenuation and η (FIG. 2). This occurs because the Hozumi-model estimates Z and α values only from the resonance-peak amplitudes in the frequency domain, rather than from the normalized spectrum over the entire bandwidth as it is done for the AR model. The peak locations and amplitudes also are affected by the attenuation which can lead to estimation errors (FIGS. 10a-10c).

FIG. 10 shows normalized spectra (N(f)) of the standard signal (i.e., “Easy”, black spectra with SNR=60 dB, d=8 μm, Z=1.63 MRayl, c=1600 m/s σ=10 dB/cm at 250 MHz, Cₚₑᵣₜ=0 and η=1) and spectra with (FIG. 10a) varied d=6 t (blue curve), and Z=1.53 MRayl (red curve); (FIG. 10b) varied α=30 dB/cm (blue curve), η=1.5 (red curve); and (FIG. 10c) varied SNR=40 dB (blue) and Cadzow de-noised spectra (red).

The results from ex-vivo-tissue experiments are consistent with those obtained from simulations and demonstrate a better performance of the AR-model as follows:

1) Analysis of the parameter-maps of the very thin sections (e.g., the cornea sample, FIG. 9) that were derived using the AR-model revealed anatomical structures that match histology more closely than parameter maps generated by the Hozumi model.

2) The Hozumi model failed to separate the two signals in more cases than the AR-model as indicated by the white areas (i.e., outliers) in FIG. 9)

3) In the thicker, 12-μm lymph-node sections, the parameter maps of the AR-model showed enhanced structural features in the Z and c parameter maps, which is a result of greater robustness and sensitivity of the AR-model to small parameter variations, as shown in the simulation results. The simulations indicate that, in low-Z and -d conditions, the AR-model produces lower variation in parameter-estimation errors and still provides reliable results when the Hozumi-model completely fails (see FIG. 2).

4) If a third signal is introduced (FIG. 4), then the AR-model performs better than the Hozumi model, which may be one reason for the better contrast of the parameter maps in the 12-μm sections (FIGS. 6-8) obtained from the experimental data. Perturbations can arise from scattering or strong reflection inside the tissue. The impact of scattering is assumed to be small because echoes from the scattering signals would be about one order of magnitude smaller than the sample-tissue and tissue-substrate interface signals, which are planar reflections. Scattering is also mitigated by the use of relatively thin samples (i.e., around the wavelength). In fact, our extensive experimental data from our previous studies did not show any larger signal between the signals of the two interface reflections, which led to the assumption of our current approach that assumes the largest amplitudes as the reflections from the water-tissue and tissue-substrate reflections. The AR approach can be tailored to pick the right two signals out of several signals by using another criterion than amplitude (e.g., time of flight, attenuation, etc.), but the existence of a prominent middle signal would also mean that our forward model (i.e., single layer) is most likely violated and estimated parameters would most likely need to be excluded. Multilayer approaches could also be taken care of using a different version of AR model.

A striking advantage of the proposed AR approach is its ability to estimate nonlinear attenuation based on a power-law model, which has not been reported to the best of the authors' knowledge. If the power-law model (i.e., the NLAR model) is used, estimating α was significantly improved compared to the Hozumi model, and the AR model shows stable results (i.e., average error in estimating α˜0 dB/MHz/cm and error-variation<0.1 dB/MHz/cm) over the entire range of simulated values and also can estimate the exponent η correctly (i.e. error variation of η≤0.4) over the simulated parameter range (FIG. 3). Biological tissues typically exhibit non-linear attenuation, but assessing ultrasound attenuation at microscopic resolutions has been challenging. However, our experimental results demonstrate the high value of the non-linear attenuation parameter of the lymph-node sample (FIG. 8). These results demonstrate the usefulness of the AR method. Accurate measurements of the non-linear attenuation also allow to assess the dispersion effects that can occur in soft tissues and can lead to speed of sound values that vary slightly with ultrasound frequency. Using causality relationships, the increase can be exactly quantified using the derivative of the frequency-dependent attenuation.

In addition, higher-quality information provided by the AR-model approach is important for modeling needs and for ultrasound applications at lower frequencies. Currently, QAM is the only method that can provide multiple acoustical and mechanical properties at fine-resolutions and over large-scale areas as is required for numerical modeling of sound propagation or finite element modeling. Such properties cannot be assessed using conventional optical microscopy methods. Use of advanced computer simulations is rising, which allows investigating complex phenomena that are difficult or cannot be examined experimentally. However, the results of these simulations will only be as accurate as the underlying models whose accuracy in turn depends on realistic input data. Furthermore, in many quantitative-ultrasound (QUS) applications, assumptions are made about the acoustic attenuation of tissue to correct QUS-parameter estimation. We hope that QAM will provide better estimates of common tissues to improve novel QUS-methods using acoustic-impedance-map methods, for example. The methods provided in the present invention to separate ultrasound signals and to estimate acoustical-parameter values also are suitable for applications at lower frequencies.

The present invention, a new AR-model, is compared with the current standard method (i.e., Hozumi-model). Although some of the improved performance of the AR-model may be directly related to implementation details, the AR model has some general advantages that are illustrated in FIG. 10, which shows representative normalized spectra for different simulated signals. The Hozumi model relies on the detection of resonance peaks in the frequency domain. In well-separated signals (FIG. 10a, Easy) with strong amplitudes, the normalized spectra exhibit several peaks that are easily detected. In theory, one maximum-minimum pair is sufficient to estimate d and c values, but additional peaks increase robustness (i.e., decrease bias and variance) to noise by averaging estimates obtained from all possible extremum pairs. Therefore, the Hozumi model is sensitive to the bandwidth of the QAM system (FIG. 10a, d), which determines the number of peaks that can be analyzed. In contrast, the AR model uses the entire normalized spectra and not only the peaks. Thus, the AR-model is more robust at the bandwidth limits (i.e., small d), as indicated by the simulation results. Similarly, the Hozumi model depends strongly on the resonance-peak amplitudes. If the amplitudes are too small, peak-detection methods may fail to detect the resonance peaks accurately. This is the case if contrast in Z between tissue and coupling medium is very small (FIG. 10a, Z). Strong attenuation (linear and non-linear) produce similar effects on the peak detection (FIG. 10b) and explain the better performance of the AR-model as observed in the simulation results. Furthermore, although not discussed in great detail here in the interest of space, the performance of the AR-model is strongly enhanced by the Cadzow denoising. FIG. 10c shows an example of a noisy signal before (FIG. 10c, SNR) and after de-noising (FIG. 10c, Cadzow) compared to a noise-free signal.

To summarize, our AR-model approach for QAM-based parameter estimation showed better performance for four highly-relevant scenarios: (i) tissues with acoustic impedance close to water, (ii) tissue samples yielding overlapping signals and (iii) tissues with nonlinear attenuation. We demonstrated in experiments and simulations the improved robustness and precision of acoustic-parameter estimation of the AR-model (e.g., smaller variation and bias of errors for samples with Z≤1.56 MRayl, d≤6 μm, α≥5 dB/MHz/cm, and η≥1). Furthermore, the AR method is easily implemented and allows direct estimation of all acoustic properties including those related to non-linear attenuation. Another advantage is the unique ability of the AR model to remove spurious signals, such as perturbation signals (FIG. 4), and still provide accurate estimates of acoustic properties. Our ex-vivo experiments demonstrate that average acoustic-parameter values are similar for both methods in 12-μm sections. However, the AR model seems to show more contrast for thinner tissue sections. This would allow to compare QAM measurements at different frequencies (e.g., 250 MHz and 500 MHz) on the same tissue samples. Furthermore, we believe that our new AR-model approach in general can markedly improve current QAM technology.

A computer system suitable for storing and/or executing program code for the present invention includes at least one processor coupled directly or indirectly to memory elements through a system bus. The memory elements include local memory employed during actual execution of the program code, bulk storage, and cache memories that provide temporary storage of at least some program code to reduce the number of times code is retrieved from bulk storage during execution. Input/output (I/O) devices (including but not limited to keyboards, displays, pointing devices, etc.) can be coupled to the computer system either directly or through intervening I/O controllers. Network adapters may also be coupled to the computer system in order to enable the computer system to become coupled to other computer systems or remote printers or storage devices through intervening private or public networks. Modems, cable modems, and Ethernet cards are just a few of the currently available types of network adapters. The computer system can also include an operating system and a compute file-system.

Although the present invention has been described in conjunction with specific embodiments, those of ordinary skill in the art will appreciate the modifications and variations that can be made without departing from the scope and the spirit of the present invention. Such modifications and variations are envisioned to be within the scope of the appended claims.

What is claimed is:

1. A method to create a parameter map depicting acoustical and mechanical properties of biological tissue at microscopic resolutions to identify potential health related issues, comprising,
mounting said biological tissue on a substrate,
raster scanning the biological tissue with an RF frequency,
recovering RF echo signals from said substrate and from a plurality of locations on said biological tissue, wherein each of the plurality of locations corresponds to a specific pixel comprising the parameter map, the recovered RF echo signals including:
a reference signal recovered from the substrate at a point devoid of tissue,
a first sample signal recovered from an interface between the biological tissue and water, and
a second sample signal recovered from an interface between said biological tissue and said substrate,
repeatedly applying a plurality of computer-generated calculation steps based on the reference signal, the first sample signal and the second sample signal to generate estimated values for a plurality of parameters associated with each of the specific pixels in the parameter map; wherein the plurality of computer-generated calculation steps including a denoising step, and using the generated estimated values to create said parameter map depicting parameters including, but not limited, to acoustic impedance, speed of sound, ultrasound attenuation, mass density, bulk modulus and nonlinear attenuation.

2. The method as recited in claim 1 wherein the biological tissue has a thickness less than 6 μm.

3. The method as recited in claim 1 the RF echo signals are two or more signals.

4. The method as recited in claim 1 wherein the acoustic impedance is less than 1.56 MRayl.

5. The method as recited in claim 1 further comprising a perturbation signal, wherein the perturbation signal is equal to or greater than 0.2.

6. The method as recited in claim 1 wherein an autoregressive model is implemented.

7. The method as recited in claim 1 further comprising estimating a non linear attenuation based on a power law model.

8. The method as recited in claim 3, wherein the signals overlap.

9. The method as recited in claim 6, wherein the autoregressive model uses an entire normalized spectra.
